(19) United States
(12) Patent Application Publication
(10) Pub. No.: US 2006/0282416 A1
(43) Pub. Date: Dec. 14, 2006

(54) Search apparatus and method for providing a collapsed search

(76) Inventors: William Gross, Pasadena, CA (US); Thomas McGovern, Pasadena, CA (US); Paul Pangaro, San Francisco, CA (US); Jason D. Levine, Los Angeles, CA (US)

Correspondence Address: CHRISTIE, PARKER & HALE, LLP, PO BOX 7068, PASADENA, CA, 91109-7068, US

(21) Appl. No.: 11/415,857

(22) Filed: May 1, 2006

Related U.S. Application Data
(60) Provisional application No. 60/676,106, filed on Apr. 29, 2005.

(51) Int. Cl. G06F 17/30

(52) U.S. Cl. 707/3

(57) ABSTRACT

An search apparatus including a field for entering a search term, and a display area for displaying a search result. The search apparatus is displayed together with a current page on a web browser, and a search result of a search can be displayed in the search apparatus. As such, the current page displayed on the web browser does not necessarily change after the search has been performed.

### CROSS-REFERENCE TO RELATED APPLICATION(S)

This application claims priority to and the benefit of U.S. Provisional Application No. 60/676,106, filed on Apr. 29, 2005, the entire content of which is incorporated herein by reference.

### FIELD OF THE INVENTION

This invention relates to web browsers and search engines, and more particularly to a search apparatus that can be used for browsing search results as well as for submitting queries in a toolbar, browser frame, desktop application, or any other client-server apparatus.

### BACKGROUND

Conventional Internet search engines and toolbar-based search engines are used for only the first part of the search process, e.g., the query submission. The second part of the process involves the display and selection or search results, which are typically loaded into the web browser and presented to the user via a separate web page rather than the search engine interface. Such existing search engines generally do not have any capabilities for displaying a search result, either collapsed or opened/expanded, through anything other than a web page.

Therefore, with a conventional Internet search engine, when a user enters a search term and hits ‘Enter’, the page/site that the user is viewing via the browser is entirely replaced with a search result page generated by the search engine. Thus, the user of a conventional search engine is unable to view the current page of interest while performing searches. Moreover, the user is unable to simultaneously view the search and search results once the user has selected a search result and directed the browser to a particular search result page. This could be problematic if the user desires to view the content of the current page while performing searches on other related or unrelated subjects of interest, or continue to view and/or refine a search after selecting and browsing to a particular search result page.

Therefore, it is desirable to provide a search engine that not only allows a user to submit queries or searches, but with which the user can also view the search results, while independently browsing to search result pages, or other pages. Further, it may be desirable for the search engine to automatically generate search queries based on the user's input in the browser.

### SUMMARY

An aspect of the present invention provides a search apparatus that not only allows a user to submit queries or searches, but with which the user can also view the search results, while independently browsing to search result pages, or other pages.

Another aspect of the present invention provides a search apparatus that automatically generates search queries based on a user's input.

In an exemplary embodiment according to the present invention, the search apparatus is a toolbar including a field for entering a search term, and a display area for displaying a search result. The toolbar is displayed together with a current page on a web browser, and a search result of a search can be displayed in the toolbar, such that the current page displayed on the web browser does not necessarily change after the search has been performed. Other embodiments of the search apparatus include browser side windows, plug-in applications, browser frames, and server applications.

In another exemplary embodiment of the present invention, a method of performing a search using a search apparatus having a search term field and a search result area, is provided. The search apparatus is displayed together with a current page on a web browser. A query is submitted by entering a search term at the search term field, wherein the result of the search is displayed in the search result area. The result of the search is viewed in the search result area, while the web browser window displays the current page, or the resultant search result pages if links thereto are selected by the user.

In yet another exemplary embodiment of the present invention, a method of performing a search using the search apparatus described above with search results appearing in the result area in real time as the search query is typed, is provided. The search query results begin to appear after the first portion of the search term is typed into the search apparatus input field, and are refined in real time as more of the search term is typed in.

In yet another exemplary embodiment of the present invention, a method of performing a search using the search apparatus described above with search terms or queries suggested by the apparatus based on a partial search term entry, as disclosed in U.S. Provisional Patent Application No. 60/671,614, entitled “Search Engine with Keyword Suggestion Tool” filed Apr. 15, 2005, U.S. Provisional Patent Application No. 60/780,785, entitled “Improved Search Engine with Keyword Suggestion Tool” filed Mar. 8, 2006, and U.S. patent application Ser. No. 11/404,944, entitled “Search Engine with Keyword Suggestion Tool and Method of Using Same” filed Apr. 14, 2006, the entire contents of all of which are incorporated by reference herein, is provided. The search query suggestions are typed into the search apparatus input field, and search term suggestions appear in a linked-popup, or temporarily in the result area.

In yet another exemplary embodiment of the present invention, a method of performing searches automatically using the search apparatus described above, based on user input outside of the search apparatus, is provided. As the user inputs a search term into an input in a browser window, search field, toolbars, operating system, or other suitable input areas, the search apparatus automatically fills in the same term, character by character, into the search apparatus and performs a search on such term.

These and other aspects/embodiments of the invention will be more readily comprehended in view of the discussion herein and accompanying drawings.

### BRIEF DESCRIPTION OF THE DRAWINGS

The accompanying drawings, together with the specification, illustrate exemplary embodiments of the present invention, and, together with the description, serve to explain the principles of some embodiments of the present invention.

FIG. 1 is a screen shot of a web page having a toolbar implementation of a search apparatus in an exemplary embodiment of the present invention.

FIG. 2 is a screen shot illustrating a toolbar implementation of a search apparatus with collapsed search results as well as search term suggestions in another exemplary embodiment of the present invention.

FIG. 3 shows a searching architecture (or a search apparatus architecture) of the search apparatus of FIG. 1 in accordance with an embodiment of the present invention.

FIG. 4 is a screen shot illustrating (i) a sidebar implementation, (ii) a browser input capture/auto-fill, and (iii) rollover site details in yet another exemplary embodiment of the present invention.

FIG. 5 is a screen shot illustrating a sidebar implementation of a search apparatus with collapsed search results in yet another exemplary embodiment of the present invention.

FIG. 6 is a screen shot illustrating a frame implementation of a search apparatus in yet another exemplary embodiment of the present invention.

FIG. 7 is a table illustrating features of various different search apparatuses in exemplary embodiments according to the present invention.

FIG. 8 is flow diagram illustrating interaction with and behavior of an embodiment of a search apparatus in accordance with the present invention.

### DETAILED DESCRIPTION

In the following detailed description, certain exemplary embodiments of the present invention are shown and described, by way of illustration. As those skilled in the art would recognize, the described exemplary embodiments may be modified in various ways, all without departing from the spirit or scope of the present invention. Accordingly, the drawings and description are to be regarded as illustrative in nature, rather than restrictive.

In an exemplary embodiment according to the present invention, a search apparatus or interface adapted to present search results to a user in one of at least two ways, e.g., to view collapsed results in conjunction with a toolbar within a browser frame of a Windows-based operating system, or to selectively view a complete listing of search results in a web page at a search site to better review the search results.

In one exemplary embodiment of the present invention, actual searching, and browsing of the associated search results, can be controlled from within the user interface of the browser search apparatus. In particular, search results and the web page being browsed by the user may be presented together in separate display areas of the same user interface. Hence, an entire search process can be collapsed into the search apparatus.

The collapsed search and display capabilities of the search apparatus in exemplary embodiments of the present invention can also be implemented in computer-readable instructions or logic in the form of a desktop application, a standalone client application, a browser plug-in application, a hosted (server-side) application, or any other client-server software arrangement. The user interface with which the user reviews search results may take the form of a frame within the browser, a side window, a pop-up menu, a pull-down menu, a shortcut menu, a cascading menu, a toolbar, a menu bar, a status bar, tabs, and/or any other form know to those skilled in the art.

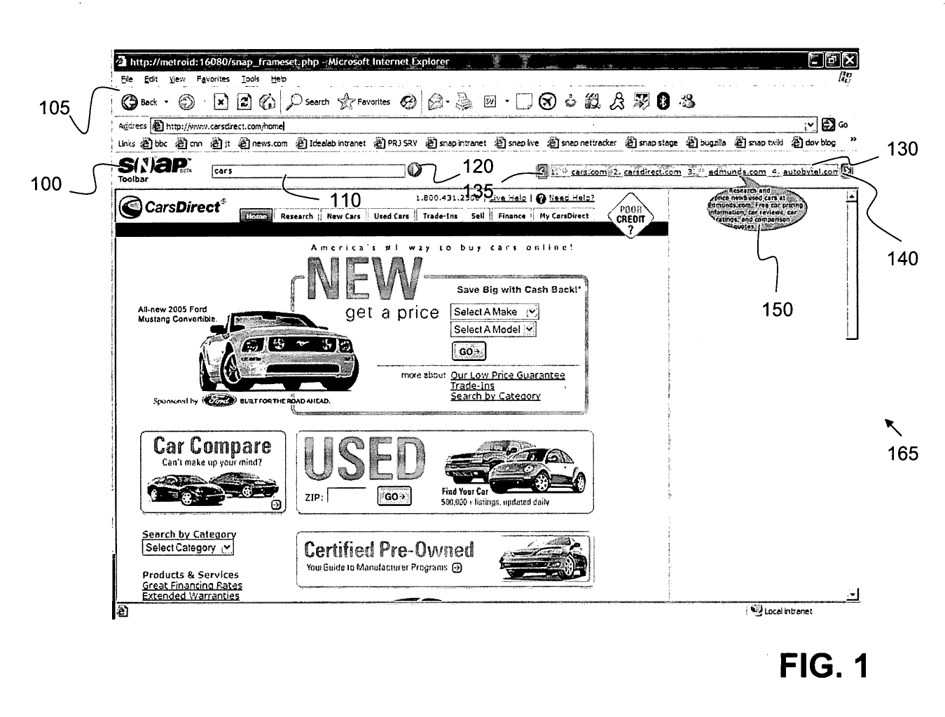

FIG. 1 is a screen shot of a browser frame depicting a web page and search apparatus 100 in accordance with an exemplary embodiment of the present invention. The conventional browser interface includes a window 165 for displaying a web page or other resource as well as the browser's standard toolbar 105 with navigation and command buttons. The search apparatus 100 in this embodiment includes a user interface in the form of a search toolbar 100 that resides in between the browser's navigation toolbar 105 and the window 165, although one skilled in the art will appreciate that the search interface may be positioned below or to the side of the browser window.

The search toolbar 100 includes a search term field 110 in which a search term or a keyword is entered, and a first display area referred to herein search result area 130 in which the results of the search are displayed. A brief descriptor of the search results 130 in this embodiment are presented in a one-dimensional array along the row of hyperlinks in the area of the search toolbar 100 to the right of the search term field 110. The depiction of each of the individual search results consists of the uniform resource locator (URL) associated with the search result. Additional information about the websites listed in the search results may be viewed by placing the cursor on or over a select search result.

In the preferred embodiment, the user enters a query in the search term field 110, the terms are submitted to a search engine, and the search results returned presented in the form of a list in the first display area. The web page, resource, or other content being presented in the second display area, referred to herein as the displayed resource, is neither changed or updated when the search results in the first display area are updated. If and when the user selects a search result in the first display area for viewing, however, the associated web pages is loaded into the browser and presented in the second display area such as the window 165.

As can be seen in FIG. 1, the user is on carsdirect.com as part of his normal browsing behavior. CARSDIRECT.COM® is a registered trademark of CarsDirect.com, a Delaware corporation. When the toolbar 100 in the exemplary embodiment of the present invention is used, the user can type in a query and view the set of results from within the toolbar 100 without leaving the original web page that he has been viewing in the window 165. This way, the user is able to conduct research while remaining on a select landing page presented in the browser window. One embodiment of the “collapsed search” search apparatus of the present invention may also be referred to as a SNAP™ toolbar.

By way of example, after a user enters the search term in the search term field 110, the user can press a search button 120 via a mouse click to execute the search. When the user requests a search by submitting a query, the search results are displayed in summary form in the search result area 130. The web page displayed in the browser window below is not affected by the execution of the search so that the user can continue to view the content of the web site without interruption. If and when the user selects a search result by clicking on the associated hyperlink, for example, the website associated with the search result is displayed in the browser window 165. This way, the user is in control of when to enter another web page rather than being redirected to another web page (e.g., the search result page) that displays the search results.

In another embodiment, a search apparatus (e.g., a search toolbar) may display search results in real time as the user progressively enters the search query, and such results may be refined automatically as each additional character of the search query is entered.

In another embodiment, a search apparatus may suggest search terms based on a portion of the search query entered into the search query field by the user. Such suggested search terms may appear as a pop-up or bubble near or under the search query field, or in the first display area prior to the initiation of the search. After the search is executed, the actual search results replace the suggested search terms.

In another embodiment, the previous two features may be combined such that a search apparatus displays suggested search terms based on the portion of the search query entered by a user at any time, and search results are also displayed in real time based on the portion of the search query entered, as is disclosed in pending U.S. patent application Ser. No. 11/404,944, entitled “SEARCH ENGINE WITH SUGGESTION TOOL AND METHOD OF USING SAME,” filed on Apr. 14, 2006, which is hereby incorporated by reference herein.

In yet another embodiment, a user may input text into a browser dialog box, URL field, or other area, and a search apparatus directly reads such input and displays search results in real time.

In certain embodiments, as can be seen in FIG. 1, the search result area 130 has displayed therein a number of web site names such as “cars.com”, “carsdirect.com”, “edmunds.com” and “autobytel.com”. AUTOBYTEL.COM® is a registered trademark of Autobytel Inc., a Delaware corporation. These web site names may include hypertext links such that the user can browse (and/or be linked to) any one of the corresponding web sites by selecting it. Also, each of the web site names may have associated thereto a brief description of the web site that can be selectively retrieved by the user. Hence, by choosing a particular web site name, for example, by placing a cursor on top of the particular web site name, a balloon 150 or pop-up window may be displayed on the web browser. The balloon 150 may, for example, provide a description of the particular web site or summary of information about the web site including the full URL with path, size of the web page, and one or more web page excerpts including the query term(s).

Also, the search toolbar 100 is adapted to present the list of search results, only a portion of which is generally visible at any given time, in a scrollable form in the search result area 130. The search result area 130 has located at its right and left sides two directional buttons 135 and 140, respectively, for horizontally scrolling (or, alternatively, vertically scrolling) the text and/or other information displayed in the search result area 130. In particular, the scroll bar may be used to review the complete list of search results returned by the associated search engine. For instance, the search result area may be scrolled simply by placing a cursor (i.e., mouse-over) on one or the other of the directional buttons. Further, with several different controls, the user can scroll the list of results, mouse-over to display meta data such as full URL, file type, site name, site description, meta tags, relevant ranking data/information, thumbnails, product images, end-user voting, comments, etc.

The search result area 130 as shown in FIG. 1 is in a collapsed state, where only the site names are visible for scrolling/browsing unless the user takes steps to display further information. If user is interest in additional information on one of the search results, the search result area can be opened or expanded to display other information by, for example, placing a cursor over the site name. The expanded search result area may be used to display graphics and/or other information related to each of the web sites found during the search.

Referring to FIG. 1, each individual search result of the search result area 130 can be expanded to display a preview or to show information about the associated website. In the preferred embodiment, the addition information presented in balloon 150 includes a brief description of the products or services rendered by the website. In some other embodiments, the search result site's thumbnails and/or product images are displayed by the search result area 130. In this case, the search result area 130 may be further expanded to display the thumbnails and/or the product images. Also, the balloon 150 may be used upon selecting one or more resulting web sites to display the thumbnails and/or the product images. This can be achieved, for example, by placing a cursor over the site name shown in the search result area 130.

Therefore, in an exemplary embodiment according to the present invention, a complete search can be requested and displayed in a search toolbar while maintaining the existing page in the window of the web browser. This way, a user can maintain function in a desired site while performing searches at the same time. Further, a search area of the search toolbar can be selectively collapsed or minimized to display minimal information and/or be selectively opened or expanded to display more information when necessary.

Also, for a set of given searches where a user has a fair grasp (or understanding) of the domains that may be display by the search results, the user can just review a list of domains ranked by the search engine with rollovers or balloons (e.g., the balloon 150) for indicating any additional information about the destination or search results sites, such as a destination site name, a destination URL, a meta tag and/or any other information regarding the web page at the destination URL. Therefore, in this exemplary embodiment according to the present invention, the user can stay within any site associated with any URL/destination that he is currently visiting and conduct search after search until a relevant URL/destination appears. A search apparatus may include icons to allow the user to manipulate, refine, and/or sort the search (e.g., scroll results, sort results, maximize results, etc.) The user can also maximize a window associated with the search apparatus into a full-frame browser window to better review the search results.

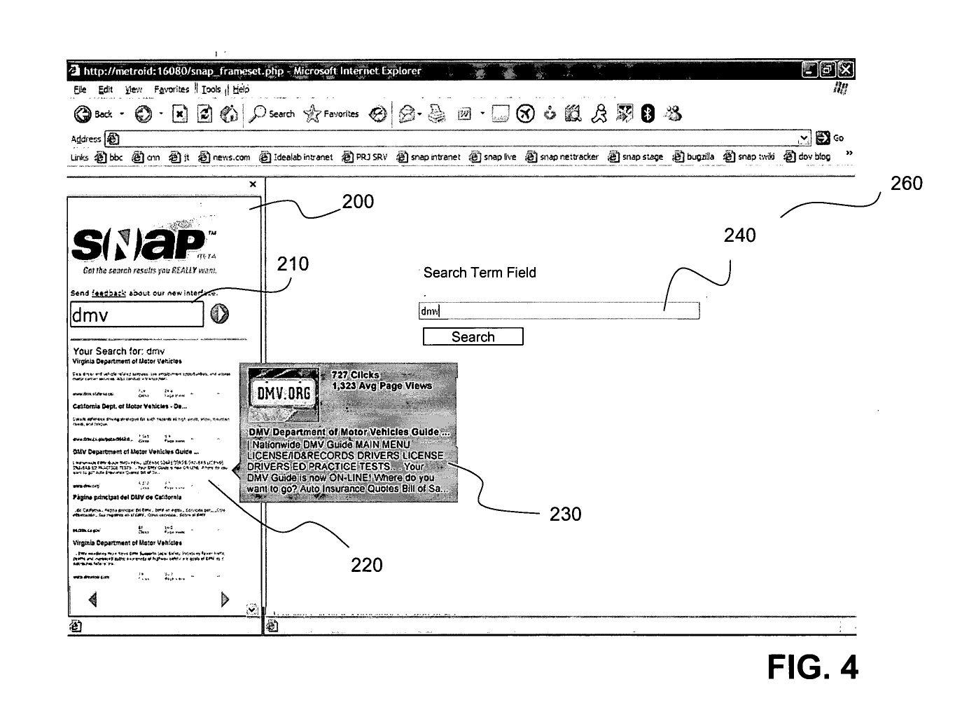

While the search apparatus (e.g., the toolbar 100) of FIG. 1 is a toolbar implementation, the search apparatus in other embodiments may exist as, without being limited to, a sidebar frame, a desktop application, a toolbar, a browser frame, or any other client-server apparatus. The search apparatuses may also continually generate and display suggested keywords as each character if the search term is typed in any apparatus including but not limited to frame, toolbar, sidebar, or desktop application. The search apparatuses may also monitor search fields in a toolbar, a browser window, or an operating system (OS) to mirror the typed-in text (e.g., as shown in FIG. 4 and described in more detail below). Further, the search apparatuses may handle many different types of searches including, but not limited to, general web search, direct question search, product search, keyword suggestion, stock quote search, weather search, and local search. In a direct question search, the user's query is in the form of a question to which the search apparatus responses with an answer, fact, or other data. In the stock quote search the user's query is in the form of a stock ticker symbol to which the search apparatus responses with the latest stock price. In the weather search, the user's query is in the form of a geographic identifier (e.g., a city or zip code) to which the search apparatus responses with weather information such as current temperature, current sun/cloud/rain conditions, or forecast.

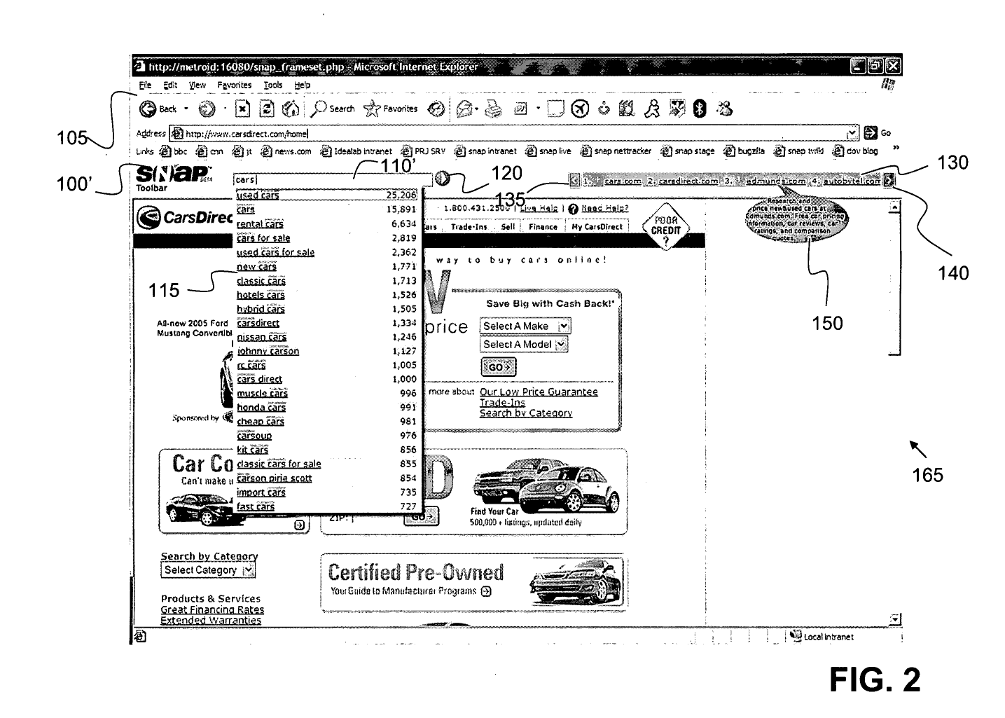

FIG. 2 shows a toolbar implementation of a search apparatus similar to that of FIG. 1. In addition to the embodiment depicted in FIG. 1, a search toolbar 100′ of FIG. 2 has a search term suggestion tool (i.e., a keyword suggestion tool) such that when the user types in a search term or a keyword (or a portion thereof) in a search term field 110′, a list of suggested search terms (or queries) is provided in a keywords area or pane 115. The plurality of suggested search terms or queries are based on previous queries entered by prior users, each of the suggested queries including one or more terms that match or are synonymous with terms of the previous queries. The user may then perform a search by selecting one of the search terms suggested by the search term suggestion tool without manually typing all the words of the full query.

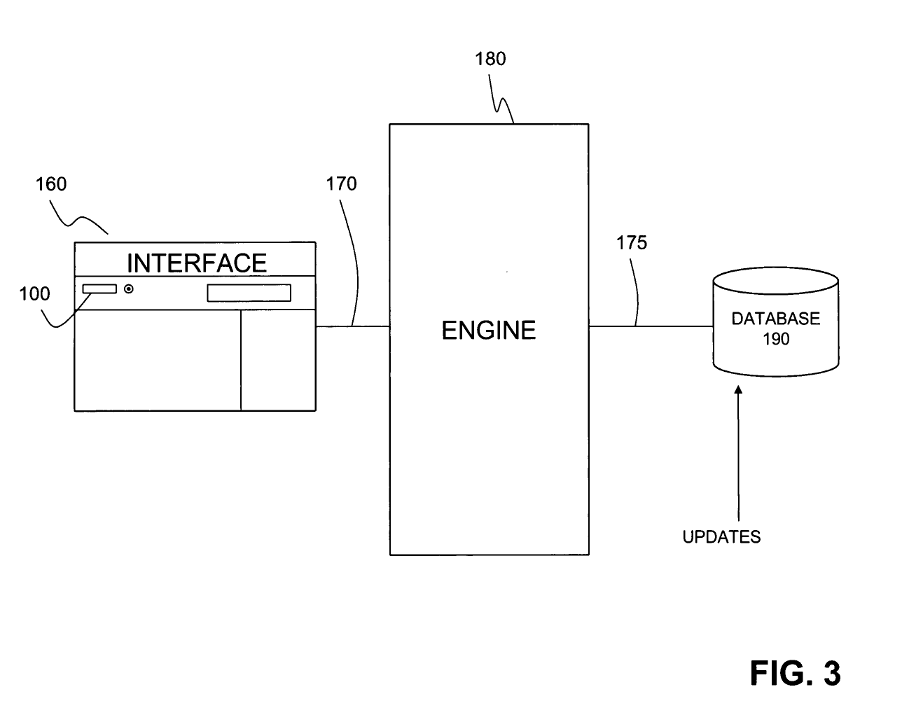

FIG. 3 shows a searching architecture (or a search apparatus architecture) for implementing the toolbar 100 according to an embodiment of the present invention. The searching architecture includes the toolbar 100, which is included in an interface 160. The interface 160 may include a web browser configured to view websites or other content accessible via the Internet. The toolbar 100 through the interface 160 is linked 170 to an engine (or a processor) 180. The link 170 may be of any scale and may include network links via networks of any size, including local area networks (LANs), metropolitan area networks (MANs), wide area networks (WANs), and the Internet, as well as any combination thereof. The link 170 may also be physical or virtual.

The engine 180 may perform computations implementing a heuristic for searching information. The engine 180 may, for example, be stored on an Internet server, which serves visitors of an Internet site via the interface 160. The engine 180 is then further linked 175 to a database 190. The link 175 may, again, be of any scale, including network links, and may be physical or virtual.

In the described embodiment as shown in FIG. 3, the engine 180 may includes one or more pre-processors to refine and/or extend search terms, to search an index of information using the refined and/or extended search terms, to generate and/or display results of the search terms, etc.

The database 190 may be used to store data usable for a heuristic to search information (e.g., an index of weighted information). The database 190 may contain information about prior searches by users of the toolbar 100 (as well as other behavioral data), user preferences, as well as any other information that may be useful for searching information. The data may be stored using any structure, including but not limited to structures that allow for quick retrieval of information based on certain search term entries and may include relationships (possibly weighted) between entries to allow for searching based on the relationship to other searches. In addition, the database 190 may contain searching information (e.g., words and/or notes) and where they were found, an index based on a weighted system for searching information, etc. In this embodiment, the database 190 is automatically and continuously updated with current searching information obtained by a World Wide Web crawler, Internet portal, Internet service provider (ISP), search engine, etc.

The searches may be continuously registered and stored by the toolbar 100 and/or the engine 180 and stored in the database 190 to be used to respond to the queries of future searchers. As such, the system continuously learns from its use and becomes more and more effective the more it is used. The system is therefore particularly valuable for Internet search portals that execute large numbers of searches by a great variety of users.

FIG. 4 is a screen shot illustrating a sidebar implementation of a search apparatus in another exemplary embodiment of the present invention. As can be seen in FIG. 4, a search apparatus (or a sidebar) 200 appears on the left side of a web browser in the described embodiment. The search apparatus 200 has a browser input capture/auto-fill feature implemented. Using this feature, keywords or search terms that are entered into a search field of the web browser (and/or a search engine) can be automatically entered in a keyword field 210 of the search apparatus 200. By way of example, by typing in the characters “dmv” in a search field (or a search term field) 240 of a web browser window (and/or a search engine page) 260, the same characters “dmv” can automatically be filled in a keyword field 210 of the search apparatus 200.

The search apparatus 200 displays multiple search results related to the characters “dmv”. One of the search results, by way of example, is “DMV Department of Motor Vehicles Guide . . . ” 220. By moving the cursor on top of this search result 220, e.g., by mouse movement or mouse-over (“mo”), a rollover or a bubble 230, which shows some details of a website (e.g., “dmv.org”) of this search result 220 can be displayed.

Consistent with the embodiment illustrated in FIG. 1, the search results are collapsed into the search result area 270, each search result being a hyperlink to an associated web page or resource. The information or website depicted in the primary browser window 260 to the right of the search result area remains static while the search is executed and the search results displayed. If and when the user selects a search result, the web page or resource associated with the search result is presented in the browser window 260.

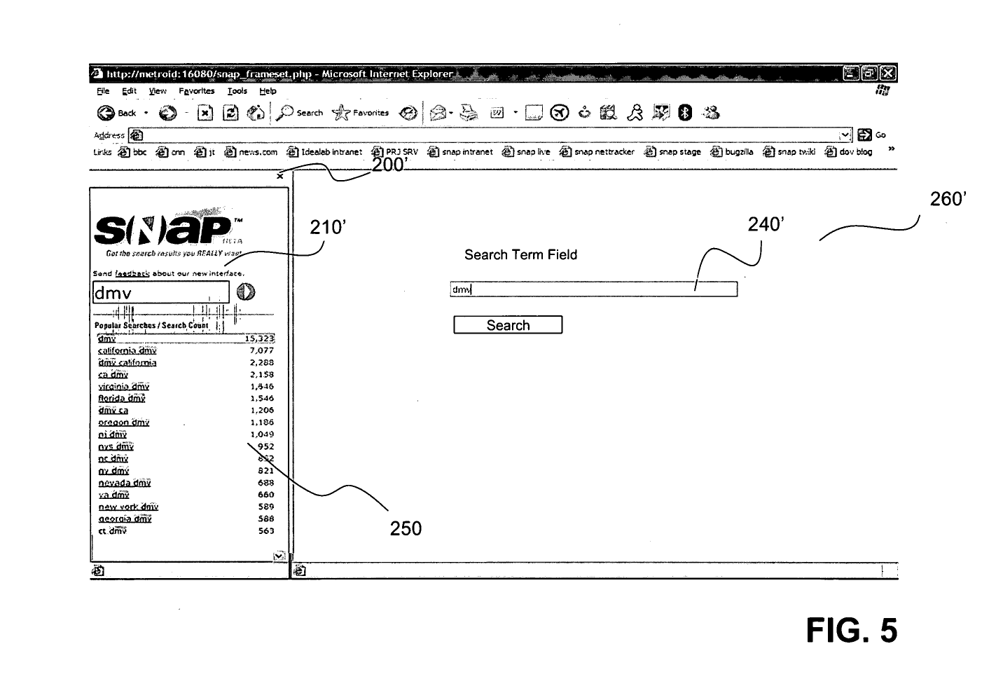

FIG. 5 is a screen shot illustrating a sidebar implementation of a search apparatus 200′ similar to the search apparatus (or sidebar) 200 of FIG. 4. Similar to the search apparatus 200, the search apparatus (or the sidebar) 200′ may have a browser input capture/auto-fill feature wherein characters input into a search field (or a search term field) 240′ of a web browser window (and/or a search engine page) 260′ are automatically filled into a keyword field 210′ of the search apparatus 200′. The plurality of suggested queries associated with the keyword(s) entered in the keyword field 210′ may be displayed in area 250. The search apparatus 200′ may subsequently display collapsed search results, which correspond to the search term “dmv” in the example depicted in FIG. 5, after the search is executed by the user.

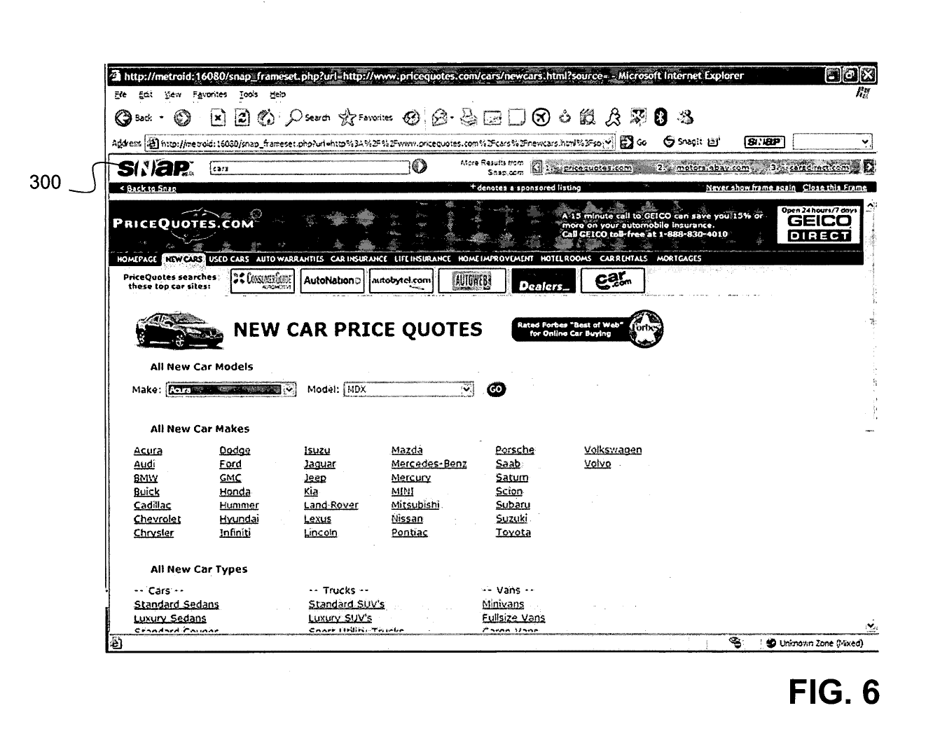

FIG. 6 is a screen shot illustrating a frame implementation of a search apparatus in yet another exemplary embodiment according to the present invention. As can be seen in FIG. 6, a search apparatus (or a frame) 300 is close in size and appearance to the search apparatus 100 of FIG. 1, which is a toolbar implementation. However, the search apparatus 300 shown in FIG. 6 is implemented as a frame (e.g., an HTML frame) of a web browser (or as a frame within a larger window for displaying a web page and/or with another frame of the web browser).

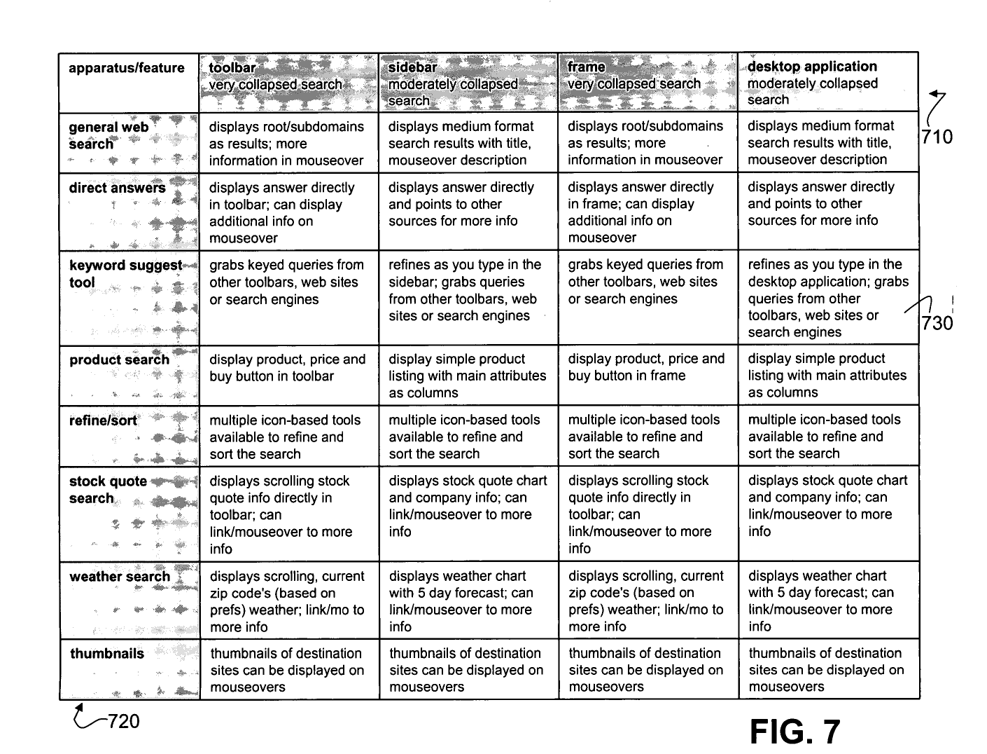

FIG. 7 is a table showing various different implementations of search apparatus according to exemplary embodiments of the present invention, search features associated with the search apparatus, and display characteristics associated with the search features and the search apparatus. For example, in a general web search and depending on the search apparatus implemented, FIG. 7 shows that a search apparatus may display root/subdomains as search results to a user or may display medium format search results with titles to the user.

The search apparatus of FIG. 7 includes toolbar and frame implementations that provide a very collapsed search (i.e., provide a very collapsible display characteristics, e.g., the implementations display root/subdomains as search results) and sidebar and desktop application implementations that provide a moderately collapsed search (i.e., provide a moderately collapsible display characteristics, e.g., the implementations display medium format search results with titles). Each of these search apparatuses can be used, for example, for one or more of, without being limited to, a general web search feature, a search feature for direct answers, a search feature based on keyword suggestion tool, a product search feature, a refine/sort feature, a stock quote search feature, a weather search feature, and/or a thumbnail viewing feature.

In the table of FIG. 7, the various types of search apparatus implementations according to certain embodiments of the present invention are listed along an upper-most row 710. The types of functional features that may be incorporated into respective search apparatus implementations are listed in FIG. 7 along a left-most column 720. The inner cells (e.g., 730) of FIG. 7 describe how a feature listed in the left-most column 720 would be implemented in the search apparatus implementation listed immediately above in the upper-most row 710.

In more detail, for the general web search feature, FIG. 7 shows that: the toolbar implementation can display root/subdomains as the search results and display more information through a user selection (e.g., through a mouse-over action); the sidebar implementation can display medium format search results with titles and display even more descriptions of the search results through a user selection (e.g., through a mouse-over action); the frame implementation can display root/subdomains as the search results and display more information through a user selection (e.g., through a mouse-over action); and the desktop application implementation can display medium format search results with titles and display even more descriptions of the search results through a user selection (e.g., through a mouse-over action).

For the search feature for direct answers, FIG. 7 shows that: the toolbar implementation can display answers to user questions directly in a display area of the toolbar implementation and can display additional information through a user selection (e.g., through a mouse-over action); the sidebar implementation can display answers directly and can point to other sources for more information; the frame implementation can display answers directly in a display area of the frame implementation and can display additional information through a user selection (e.g., through a mouse-over action); and the desktop application implementation can display answers directly and can point to other sources for more information.

For the search feature based on keyword suggestion tool, FIG. 7 shows that: the toolbar implementation can grab keyed queries from other toolbars, web sites, search engines, etc.; the sidebar implementation can refine suggested queries as a user types in a search term and can grab queries from other toolbars, websites, search engines, etc.; the frame implementation can grab keyed queries from other toolbars, web sites, etc.; and the desktop application implementation can refine as a user types in a search term and can grab queries from other toolbars, websites, search engines, etc.

For the product search feature, FIG. 7 shows that: the toolbar implementation can display product, price, and buy buttons in the toolbar implementation; the sidebar implementation can display simple product listing with main attributes in columns of the sidebar implementation; the frame implementation can display product, price, and buy buttons in the frame implementation; and the desktop application implementation can display simple product listing with main attributes in columns of the desktop application implementation.

For the refine/sort search feature, FIG. 7 shows that multiple icon-based tools can be available to refine and sort the search results in the toolbar implementation, in the sidebar implementation, in the frame implementation displays product, and in the desktop application implementation.

For the stock quote search feature, FIG. 7 shows that: each of the toolbar implementation and the frame implementation can display product displays scrolling stock quote information and can link/mouse-over to more information; and each of the sidebar implementation and the desktop application implementation can display stock quote chart and company information and can link/mouse-over to more information.

For the weather search feature, FIG. 7 shows that: both the toolbar implementation and the frame implementation can display scrolling, current zip code's (e.g., based on one or more preferences) weather and link/mouse-over to more information; and each of the sidebar implementation and the desktop application implementation can display weather charts with a multi-day forecast and can link/mouse-over to more information.

For the thumbnail viewing feature, FIG. 7 shows that: the toolbar implementation, the sidebar implementation, the frame implementation, and the frame implementation can all display thumbnails of destination sites that can be displayed on user selections and/or mouse-overs.

As such, as shown in the table of FIG. 7, the search apparatus can also provide functions such as: allowing the user to answer questions directly in the toolbar (for example, a search on the population of a certain city may return an actual figure rather than a link to a related website); allowing the user to input a stock quote search and receive scrolling stock information directly in the search apparatus; and allowing weather search results directly in the search apparatus. Further, the search results may also be refined or sorted using multiple icon-based tools provided by the search apparatus. By way of example, the search apparatus may allow for additional searches based on the search results in the search result area. The search results may be sorted based on alphabetical order, relevance, and/or the like.

It should be noted that the types of search apparatuses and the features thereof of FIG. 7 are provided for illustrative purposes only, and the present invention is not limited thereto. By way of example, as discussed above, the search apparatus may be implemented in various other formats such as a desktop application, a stand alone client application, a server-side application and/or the like.

Further, the search apparatus may have other features that are not listed in the table of FIG. 7. By way of example, the search apparatus can build search-and-results history, and also dynamically scroll results that are similar to the currently viewed page. The search apparatus may also have one or more action buttons placed in the search result area and/or other portions. The action buttons may be used to initiate actions such as search, buy, download, play media, and/or the like. The search apparatus may also provide form elements in the search results (e.g., zip code, email address, etc.). Using the search apparatus, the user may also view specific feed information such as eBay® API, Amazon® API, etc. eBay is a registered trademark of eBay Inc., a Delaware corporation. Amazon is a registered trademark of Amazon.com, Inc., a Delaware corporation.

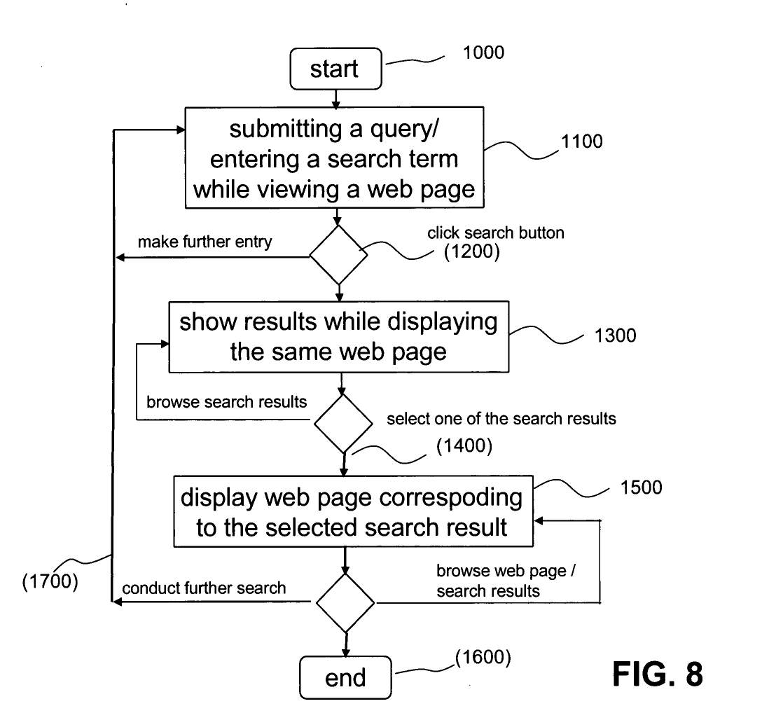

FIG. 8 shows a method by which a user may interact with an exemplary embodiment of the present invention. As illustrated for the exemplary embodiment of FIG. 8, a user interested in searching for information may start (1000) by submitting a query of a search by entering a search term at a search term field, while viewing a web page displayed by a web browser (1100). Once the user executes a search, for example by clicking a search button (1200), one or more results of the search are displayed in a search result area of the search apparatus, while the current web page is still being displayed by the web browser (1300). As such, the user can than browse the results of the search in the search result area, while the web browser is still displaying the current web page to the user (1300).

In one embodiment, during the entry (1100) of a partial search term, the system may provide one or more suggestions of the search term and/or other related suggestions.

In another embodiment, the search results may be displayed in real time as the user progressively enters the search term and the results may be refined automatically as more of the search term is entered.

In another embodiment, the above suggestion and real time display features may be combined such that the search apparatus displays suggestion to the search term based on the portion of the partial search term entered by the user at any time, and the search results are also displayed in real time based on the portion of the search term entered.

In yet another embodiment, the user may input text into another application, e.g., browser dialog box, URL field, or other area, and the search apparatus directly reads such input and displays the search result.

Once the user has browsed the results of the search in the search result area, while the web browser is still displaying the current page to the user, the user may select one of the search results to leave the current page (1400), and be moved to a new page (or a new web page) corresponding to the selected search results (1500), and the user may then continue to browse the new page (or the new web page). The search results may still be displayed by the browser to the user. Then, the user may finish (1600) his search (and may also delete the search results if they were still being displayed), or should the user not be satisfied with the search results, the user is always free to conduct further searches (1700). The user may, of course, also, at any time, abort one search and simply begin modifying/entering the search term (1100) in support of another search, without ever having executed the earlier search (e.g., without having clicked the search button).

The flow illustrated in the flow diagram in FIG. 8 is to be understood to be merely illustrative of one exemplary embodiment and not as restrictive. Many variations are contemplated and included in the scope of the present invention, including changing the order of individual steps and/or executing steps in a parallel manner that are shown in sequence in the chart. One example of parallel execution may be the showing of the search results (1300), which may happen as soon as the search is being entered or filled (1100). The actual timing of the execution of these steps may often depend on other factors, such as network speed and traffic, and is not restricted simply because of the specific order that has been chosen for FIG. 8 in order to provide a readable chart for illustrative purposes.

In addition, the results and/or the current page (1300) displayed and/or showed by the search apparatus do not have to be limited to web sites and/or web pages, but may include other and/or additional information, such as maps, stock quotes and/or general company information.

While the invention has been described in connection with certain exemplary embodiments, it is to be understood by those skilled in the art that the invention is not limited to the disclosed embodiments, but, on the contrary, is intended to cover various modifications included within the spirit and scope of the appended claims and equivalents thereof.

We claim:

1. A search apparatus operably coupled to a search engine, the search apparatus comprising:
a field adapted to receive at least one search term for submission to the search engine; and
a user interface comprising:
a first display area for displaying a plurality of search results relevant to the at least one search term from the search engine, wherein each of the plurality of search results is associated with a resource; and
a second display area configured to displaying the resources associated with the plurality of search results,
wherein a displayed resource in the second display area is unchanged while the first display area is updated with the plurality of search results;
wherein the displayed resource in the second display area is updated with at least one of the resources associated with the plurality of search results in response to user selection of at least one of the search results.

2. The search apparatus of claim 1, wherein the plurality of search results displayed in the first display area consist essentially of uniform resource locators.

3. The search apparatus of claim 2, wherein the resources associated with the plurality of search results comprise web pages.

4. The search apparatus of claim 1, wherein the displayed resource in the second display area comprises a current page displayed by a web browser, and the first display area is adapted to display the plurality of search results, such that the current page can be displayed together with the search results after the first display area is updated with the plurality of search results.

5. The search apparatus of claim 1, wherein the search apparatus provides one or more suggestions for the search term using a partial search term entered, while a user is entering the search term.

6. The search apparatus of claim 1, wherein the search apparatus is displayed together with a display of another application having a term input field, and wherein the field for entering the search term can be automatically filled by entering the search term into the term input field of the display of the another application.

7. The search apparatus of claim 6, wherein the another application is a web browser, a toolbar, and/or an operating system.

8. The search apparatus of claim 1, wherein the search result of the search is displayed in real time as the search term is progressively being entered into the field for entering the search term.

9. The search apparatus of claim 8, wherein the search results are automatically refined as more of the search term is entered.

10. The search apparatus of claim 1, wherein the search apparatus provides one or more suggestions for the search term using a partial search term entered, while a user is entering the search term, and wherein the search results are displayed in real time as the search term is progressively being entered into the field for entering the search term.

11. The search apparatus of claim 1, wherein the display area has a directional button for scrolling text and/or other information of the search results displayed in the first display area.

12. The search apparatus of claim 1, further comprising a control for displaying meta data associated with the search results displayed in the first display area.

13. The search apparatus of claim 1, wherein the first display area can be opened or expanded to display other information of the search result.

14. The search apparatus of claim 13, wherein the other information includes graphics and/or other information relating to a web site.

15. The search apparatus of claim 13, wherein the other information includes a thumbnail and/or a product image.

16. The search apparatus of claim 1, wherein the search apparatus is implemented through a toolbar.

17. The search apparatus of claim 1, wherein the search apparatus is implements through a sidebar.

18. The search apparatus of claim 1, wherein the search apparatus is implemented through a frame of a web browser.

19. The search apparatus of claim 1, wherein the search apparatus is implemented through a desktop application.

20. A method of performing a search using a search apparatus having a search term field and a search result area, the search apparatus being displayed together with a current page on a web browser, the method comprising:
submitting a query of a search by entering a search term at the search term field, wherein the result of the search is displayed in the search result area; and
browsing the result of the search in the search result area, while the web browser displays the current page.

21. The method of claim 20, further comprising:
providing one or more suggestions for the search term using a partial search term entered, while a user is entering the search term.

22. The method of claim 20, wherein the browsing of the result is displayed in real time as the search term is progressively being entered into the search term field.

23. The method of claim 22, further comprising:
automatically refining the result of the search as more of the search term is entered.

24. The method of claim 20, wherein the search term field is implemented as part of a display of another application, and wherein the submitting the query comprises:
automatically entering the search term into the search apparatus while the search term is being entered into the search term field of the display of the another application.

25. A search apparatus comprising:
a field for entering a search term of a search; and
a display area for displaying a search result of the search,
wherein the search apparatus is displayed together with a graphic display of another application having a text input field, wherein the field for entering the search term can be automatically filled by entering the search term into the text input field of the graphic display of the another application.

26. The search apparatus of claim 25, wherein the another application is a web browser, a toolbar, and/or an operating system.
